(19) United States
(12) Patent Application Publication
(10) Pub. No.: US 2007/0204260 A1
(43) Pub. Date: Aug. 30, 2007

(54) Program transformation system

(75) Inventor: Kenji Ishizuka, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd.

(21) Appl. No.: 11/702,094

(22) Filed: Feb. 5, 2007

(30) Foreign Application Priority Data
Feb. 24, 2006 (JP) 2006-047714

(51) Int. Cl. G06F 9/44

(52) U.S. Cl. 717/162

(57) ABSTRACT

The present invention provides a program transformation system that generates object programs each adapted to an actual operating state and most suitable for satisfying performance requested by a programmer. The program transformation system includes a compiler that generates object programs from a source program in accordance with optimization instruction information, a linker that links the object programs to generate an executable load module, a simulator (or emulator) that executes the load module to generate profile information, a profile analysis processor that compares the profile information and a programmer's performance request, generates optimization instruction information so as to satisfy the performance request and gives the same to the compiler, and a program loader that performs recompile processing in accordance with instructions issued from the profile analysis processor. Thus, optimization items are sequentially added so as to meet the performance request and hence the optimum object program can be produced.

### BACKGROUND OF THE INVENTION

The present invention relates to a program transformation system such as a compiler, which transforms a source program described in a high-level programming language to an object program directly decodable by a computer, and particularly to optimization control on its transformation processing.

Hitherto, a compiler has been configured so as to convert or transform a source program (source code) to an object program (assembly code or object code) using a suitable optimization method. As optimization methods, may be mentioned, rate optimization for making an execution rate of an object program the fastest, code optimization for minimizing the size of a produced object program, etc. Therefore, the compiler is constructed so as to generate an object program by analyzing the structure of the source program and applying the rate optimization or the optimization method adapted to the code optimization according to the contents of an optimization request. In view of the fact that the conventional compiler encountered difficulties in optimization having matched an actual operating condition of an application program, an object program optimizing method for executing the trial of each created object program, recording an internal dynamic state of a computer based on it and further optimizing a non-optimized portion, based on the recorded contents has been described in a patent document 1 (Japanese Unexamined Patent Publication No. Hei 7(1995)-64799).

Although, however, the conventional compiler and the optimization method described in the patent document 1 bring about a predetermined effect upon a specific operation of the object program, there is no guarantee that it satisfies the performance requested by a programmer.

### SUMMARY OF THE INVENTION

The present invention aims to provide a program transformation system which generates object programs each adapted to an actual operating state and most suitable for satisfying performance requested by a programmer.

According to one aspect of the present invention, for attaining the above object, there is provided a program transformation system comprising:

compilation means that performs optimization processing within a predetermined range of threshold values, based on optimization instruction information when the optimization instruction information is given, and that, when the optimization instruction information is not given, performs optimization processing, based on prescribed designation information to transform a source program to an object program and outputs optimization information used in the optimization processing along with the object program;

linkage means that generates a load module, based on the object program outputted from the compilation means;

execution means that executes the load module and outputs profile information constituted of the optimization information and execution-time information related to the optimization information;

analysis means that compares a given performance request and the execution-time information contained in the profile information and that terminates processing when the performance request is met and sequentially changes each optimization item contained in the profile information by a predetermined number of times when the performance request is not met, and that supplies the same to the compilation means as the optimization instruction information and gives recompile instructions; and

control means that operates the compilation means, the linkage means and the execution means sequentially thereby to control program transformation processing.

The present invention includes analysis means which compares a performance request and execution-time information and which sequentially changes each optimization item by a predetermined number of times when the performance request is not met and feeds back optimization instructions to compilation means, the compilation means which performs a recompile in accordance with the optimization instructions, and linkage means, execution means and control means for executing a recompiled object program. Thus, an advantageous effect is brought about in that an optimum object program that satisfies the performance requested by a programmer in association with an actual operating state can be generated.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram of a program transformation system showing one embodiment of the present invention; and

FIG. 2 is an operation explanatory diagram of FIG. 1.

### DETAILED DESCRIPTION OF THE PREFERRED EMBODIMENTS

The above and other objects and novel features of the present invention will become more completely apparent from the following descriptions of preferred embodiments when the same is read with reference to the accompanying drawings. The drawings, however, are for the purpose of illustration only and by no means limitative of the invention.

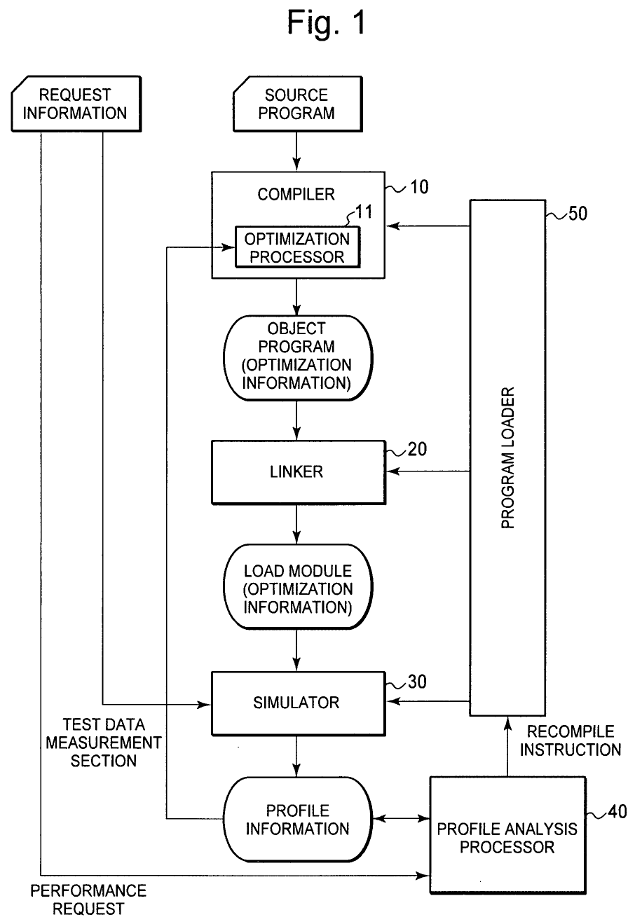

FIG. 1 is a block diagram of a program transformation system showing one embodiment of the present invention.

The program transformation system utilizes hardware resources of a general computer and transforms a source program into an object program by software processing. The program transformation system comprises compilation or translation means (e.g., compiler) 10, linkage means (e.g., linker) 20, executing or execution means (e.g., simulator or emulator) 30, analysis or analyzing means (e.g., profile analysis processor) 40 and control means (e.g., program loader) 50.

Incidentally, as the hardware resources may be used with a keyboard for inputting input data such as a source program and test data, a central processing unit for executing logical operation processing in accordance with software control, a memory for storing a program and data being in processing therein, a hard disk for storing a generated object program and the like therein, and a display or the like for displaying the result of processing to a programmer.

The compiler 10 transforms the source program described in a high-level programming language (source code) given as input data to its corresponding object program such as an object code or the like directly decodable by a computer. An optimizing processor 11 for optimizing the speed or rate and size of an object program generated in accordance with optimization instruction information is contained in the compiler 10. The optimizing processor 11 effects optimization processing on processing given no optimization instruction information in accordance with a predetermined condition and effects optimization processing on processing given the optimization instruction information within a predetermined threshold range on the basis of the optimization instruction information. The object program generated by the compiler 10 is supplied to the linker 20 together with the optimization information applied at the optimizing processor 11.

The linker 20 links a plurality of object programs (including ones registered as subroutines or the like in advance in addition to the object program outputted from the compiler 10) to produce one executable load module. The load module generated at the liner 20 is outputted to the simulator 30 together with the optimization information given from the compiler 10.

The simulator 30 executes the load module using test data prepared by the programmer or the like and acquires or collects run-time information to generate profile information. The profile information is constructed in such a manner that the optimization information and the run-time information are associated with each other. The run-time information contains information about the position of each program intended for optimization, an execution time for processing corresponding to each position, etc. The profile information obtained by executing the load module by the simulator 30 is outputted to the profile analysis processor 40.

The profile analysis processor 40 compares the contents of request information corresponding to a performance request supplied from the programmer and the contents of the run-time information contained in the profile information outputted from the simulator 30, changes the optimization information such that the request made from the programmer is met, and gives recompile instructions. That is, if the profile information is analyzed and the contents of the run-time information meets the request made from the programmer, then the profile analysis processor 40 terminates compile processing. If the contents of the run-time information does not satisfy the request made from the programmer, then the profile analysis processor 40 changes an optimization item contained in the optimization information and supplies the same to the compiler 10. Thereafter, the profile analysis processor 40 gives recompile instructions to the program loader 50. This operation is terminated when the request of the programmer is met or the preset condition is reached.

The program loader 50 starts or activates the compiler 10, the linker 20 and the simulator 30 in turn thereby to control a series of program transformation processes. The activation of the first compile processing by the program loader 50 is started in accordance with the instructions of the programmer, whereas each of recompile processes subsequent to the second time is started in accordance with recompile instructions given from the profile analysis processor 40.

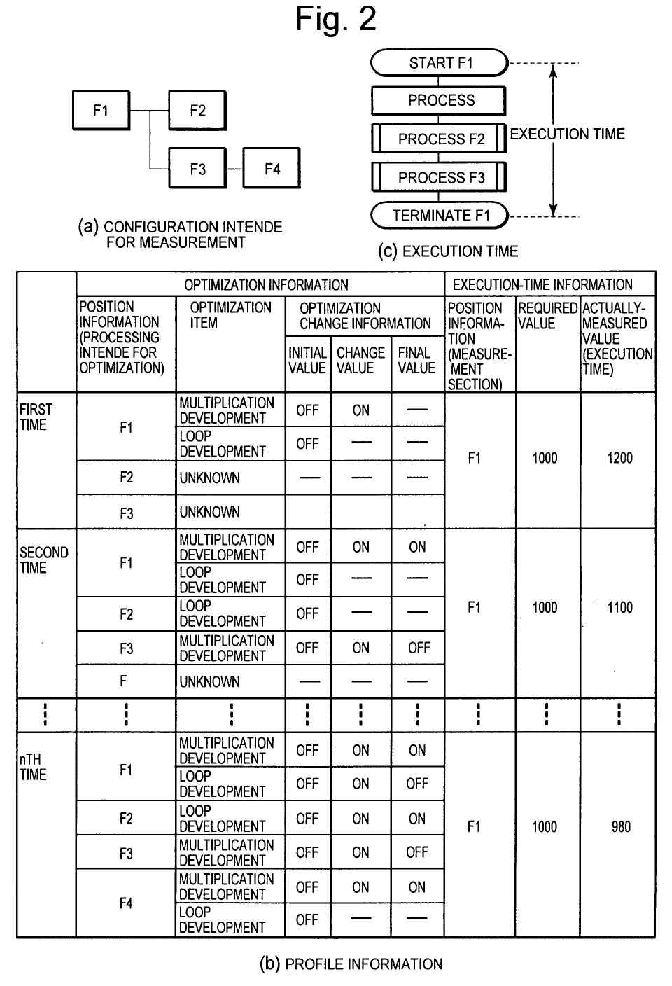

FIG. 2 is an operation explanatory diagram of FIG. 1. The operation of FIG. 1 will be explained below while referring to FIG. 2 appropriately.

When a source program, test data and request information are given from the programmer and instructions for the start of compilation are given, the program loader 50 starts up the compiler 10.

The compiler 10 reads the source program. Here, a location to be measured in the source program corresponds to a process or processing F1 as shown in FIG. 2(a). Let's assume that the process F1 has already invoked processes F2 and F3 defined in an external module, and a process F4 is further being invoked from the process F3. The performance that the programmer requires for the process F1 is assumed to be an execution time of 1000 cycles.

The compiler 10 sequentially transforms each read source program. When the process F1 reaches a compile target, the compiler 10 records the presence or absence of execution of an optimization item for the process F1 as an initial value (in the figure, “off” indicates non-executed and “on” indicates executed) as shown in FIG. 2(b). When it is found out that the process F2 and the process F3 are invoked from the process F1 while the process F1 is being compiled, the compiler 10 records initial values of optimization items corresponding to the processes F1 and F3. When, however, the processes F2 and F3 have already been compiled before compilation of the process F1 taken as conductive thereto, information about their optimization items are not recorded. Therefore, it is described that the information about the optimization items for the processes F2 and F3 are recorded from the next time onwards (defined as “unknown” in the figure). When other processing is further invoked where the processes F2 and F3 are being compiled, the compiler 10 additionally records information about the optimization items for the processes F2 and F3 in sequence.

When the first compile by the compiler 10 is terminated and an object program is created, the object program is supplied to the linker 20 together with optimization information.

In the linker 20, the object program is linked to other object program as needed, so that one executable load module is created. The load module generated at the linker 20 is outputted to the simulator 30 together with the optimization information given from the compiler 10. In the simulator 30, the load module is executed using the test data supplied from the programmer. With the execution of the load module, execution times are acquired or collected so that each profile information added with execution-time information is generated as shown in FIG. 2(b). Here, the execution time indicates the number of cycles from the commencement of the process F1 to its end as shown in FIG. 2(c). The times necessary for the processes F2 and F3 invoked from the process F1 are also contained therein. The profile information about the first result of measurement by the simulator 30 is supplied to the profile analysis processor 40.

The profile analysis processor 40 starts the analysis of the profile information outputted from the simulator 30.

It is understood from the first result of measurement that the optimization of multiplication development and loop development corresponding to the optimization items for the process F1 are not executed and the execution time of the process F1 is 1200 cycles. Incidentally, the multiplication development means that its processing is substituted with a combined operation of a shift instruction and an addition instruction without using a multiplication library at a constant expression and multiplication processing to thereby realize an improvement in speed. The loop development means that repeatedly-executed processing bodies are developed as instructions by the repetitive number of times to thereby realize an improvement in speed.

The compiler 10 determines that an increase in program size with the execution of the multiplication development and loop development for the process F1 is not adequate, and thereby inhibits these developments. It is found out that as a result of the execution by the simulator 30, however, the execution time exceeds 1000 cycles corresponding to a request made from the programmer and hence the programmer's request is not met.

The profile analysis processor 40 compares a programmer's required value and an actually measured value. Further, in order to satisfy the performance requested by the programmer, the profile analysis processor 40 renews optimization change information (change value) for the profile information into “on” in such a manner that the inhibited optimization item is executed at the first time. At this time, the optimization items little affected by an increase in program size are sequentially updated on a preferential basis without collectively updating change requests for optimization. In FIG. 2(b), the multiplication development has priority over the loop development assuming that the multiplication development is less reduced in the increase in program size as compared with the loop development.

The optimization change information for the first result of measurement generated at the profile analysis processor 40 is fed back to the compiler 10 as the profile information. Further, the profile analysis processor 40 outputs recompile instructions to the program loader 50. Thus, the program loader 50 starts up the compiler 10 to allow the compiler 10 to start a second compile.

The compiler 10 performs optimization processing in accordance with the optimization change information given from the profile analysis processor 40 to generate or produce an object program corresponding to the second time and outputs it to the linker 20 along with actually-applied optimization information.

Processes for the generation of a second load module by the linker 20, the execution of the second load module by the simulator 30 and the analysis of second run-time information by the profile analysis processor 40 and the like are carried out in a manner similar to the processes at the first time. When the actually-measured value does not satisfy the programmer's required value even in the second processing, the profile analysis processor 40 adds further optimization change information and performs third compile processing.

Such compile processing is repeatedly performed until the actually-measured value satisfies a programmer's required value or reaches a preset condition. The preset condition will be explained here.

The profile analysis processor 40 sequentially adds optimization change information for executing optimization processing items in such a manner that an actually-measured value satisfies a programmer's required value. On the other hand, the optimizing processor 11 of the compiler 10 refers to the profile information and attempts to apply the corresponding optimization item to processing intended for the source program where a change request for optimization is designated and a final value for execution of the optimization item is not obtained. When, however, the respective optimization processing items are applied unconditionally, there may be cases where side effects such as enlargement of a created program size, an increase in compile time due to enlargement of an optimization scale, etc. occur. Therefore, it is general that threshold values are provided to inhibit the occurrence of these side effects.

The present embodiment is characterized in that two types of threshold values corresponding to a standard value and an allowable value are utilized at the optimizing processor 11. The standard value and the allowable value are respectively threshold values for determining whether the execution of optimization items set every optimization item is enabled. The contents of the threshold values depend upon the optimization item and are expressed in the number of bits, the number of syntactic tree nodes, the number of bytes and the like.

The standard value is a value used where the execution of optimization is not designated by the profile information. The allowable value is a value used where the execution of optimization is designated by the profile information. The allowable value has a relationship with the standard value to relax the execution of the optimization item. The operation of the optimizing processor 11 using the standard value and the allowable value will be explained below with the multiplication development as an example.

Let's assume that the threshold values for the multiplication development are expressed in the number of syntactic tree nodes and set to a standard value 20 and an allowable value 40. The number of syntactic tree nodes intended for optimization on which the optimizing processor 11 focuses attention at present is assumed to be 25.

When the optimization instruction for multiplication development does not exist in a request for the change of profile information, the standard value is used as the threshold value for optimization execution. In this case, the number of syntactic tree nodes intended for optimization is 25 and exceeds the standard value 20. Therefore, the multiplication development is not executed even though the multiplication development is instructed at the compiler's option or the like.

On the other hand, when the optimization instruction for multiplication development exists in the request for the change of profile information, the allowable value is used as the threshold value for the execution of optimization. In this case, the number of syntactic tree nodes intended for optimization is 25 and does not exceed the allowable value 40. Thus, the multiplication development is carried out. At this time, the final value “on” indicating that the multiplication development has been executed as the optimization item is recorded as the final value for optimization change information as shown in the second process F1 in FIG. 2(b). When the number of syntactic tree nodes intended for optimization exceeds the allowable value in reverse, no multiplication development is carried out even though the optimization instructions for the multiplication development are given by the optimization change information. Thus, the final value “off” indicating that the optimization item is not carried out is recorded as the final value for the optimization change information as shown in the second process F3 in FIG. 2(b).

Even in the case in which the execution of the optimization item is instructed from the profile analysis processor 40 in this way, the optimizing processor 11 of the compiler 10 is configured so as to determine whether the execution of optimization based on the threshold value is enabled. Thus, since the range of execution of optimization is limited, an improvement in the performance of the whole object program is realized with minimum side effects.

As described above, the program transformation system according to the present embodiment brings about the following advantages.

(a) The program transformation system includes the profile analysis processor 40 which outputs the optimization change information for sequentially increasing the optimization items so as to meet the performance request given from the programmer, based on the profile information containing the optimization information indicative of the contents of the optimization processing executed by the optimizing processor 11 of the compiler 10 and the run-time information indicative of the result of execution of the load module by the simulator 30, and the program loader 50 which sequentially starts up the compiler 10, the linker 20 and the simulator 30 based on the recompile designation or instructions outputted from the profile analysis processor 40 to allow them to the recompile processing. It is thus possible to generate the optimum object program that adapts to an actual operating state and satisfies the performance requested by the programmer.

(b) Optimizing control at a general compiler makes use of grammars peculiar to compilers of respective companies called option designation, programmers and special keywords. Therefore, the descriptions of the programmer and the special keyword must be changed according to the grammar of a compiler intended for transportation upon transporting the source program to other company or another target (computer or the like). Since, however, the program transformation system according to the present embodiment does not use the grammar peculiar to each compiler, the source program can be transported to other target with ease.

Incidentally, although the program transformation system is constituted of the five elements of the compiler, linker, simulator (or emulator), profile analysis processor and program loader in the present embodiment, the classification of constituent elements is not limited to the illustrated ones.

The present invention is not limited to the above embodiment. That is, the present invention can be applied to a compiler that generates a machine language or assembler codes of a target system, and a system capable of executing the machine language produced by the compiler.

What is claimed is:

1. A program transformation system comprising:
compilation means that performs optimization processing within a predetermined range of threshold values, based on optimization instruction information when the optimization instruction information is given, and that, when the optimization instruction information is not given, performs optimization processing, based on prescribed designation information to transform a source program to an object program and outputs optimization information used in the optimization processing along with the object program;
linkage means that generates a load module, based on the object program outputted from the compilation means;
execution means that executes the load module and outputs profile information constituted of the optimization information and execution-time information related to the optimization information;
analysis means that compares a given performance request and the execution-time information contained in the profile information and that terminates processing when the performance request is met and sequentially changes each optimization item contained in the profile information by a predetermined number of times when the performance request is not met, and that supplies the same to the compilation means as the optimization instruction information and gives recompile instructions; and
control means that operates the compilation means, the linkage means and the execution means sequentially thereby to control program transformation processing.
